(19) United States
(12) Patent Application Publication
(10) Pub. No.: US 2013/0183114 A1
(43) Pub. Date: Jul. 18, 2013

(54) MULTIPLE ANGLE VALVE SEAT CUTTER BLADES AND METHOD

(71) Applicants: Ricardo Bermea, Del Rio, TX (US); Ricardo Bermea, Del Rio, TX (US)

(72) Inventors: Ricardo Bermea, Del Rio, TX (US); Ricardo Bermea, Del Rio, TX (US)

(21) Appl. No.: 13/349,666

(22) Filed: Jan. 13, 2012

(51) Int. Cl. B23C 3/05; B23C 5/02; B23C 5/20

(52) U.S. Cl. 409/131; 407/115

(57) ABSTRACT

A blade for cutting multi-angle valve seat profiles has a plurality of angles machined on its surface which combine to form rake and relief angles that machine concentric valve seats and chatter free finishes. The method of machining several valve seat angles in one cycle of valve cutter as opposed to having multiple valve seat cutters at different angles will accelerate the task of machining valve seats on cylinder heads on internal combustion engines.

### BACKGROUND

1. Field

This invention relates to a valve seat cutter and more particularly refers to a cutter blade that has a multi-angle profile for shaping valve seats.

2. Prior Art

Cylinder head valve seats and valves widely used in internal combustion engines such as gasoline and diesel engines tend to lose their initial sealing qualities after extended use. Thus, it is common practice to periodically refinish the sealing faces of the poppet valves, generally by a grinding operation, and of the valve seats using various methods.

Of these methods for refinishing the valve seats have known to be unsatisfactory in the trade. Valve seats have been refinished, for example, by rotable lapping with a ground valve and suitable lapping abrasive. Valve and seat are interposed bringing sealing surfaces thereof to the same contour. This method cannot, however in a practical amount of time, return a badly distorted seat to its proper angle and to coaxiality with its associated valve guide. If valve seats are only partially lapped; may result in binding of the valve stem in its guide when the valve is closed. Due to the increase in number of valves per cylinder heads, this method will prove to be an inefficient use of man power and resources, as the lapping abrasive will not reshape hardened seats to a concentric and smooth surface.

Grinding of the seat has not been desirable as badly distorted seats quickly change the contour of the grinding wheel which must be frequently redressed. This is a time consuming, and hence expensive operation. As stated above the increase in number of valves per cylinder and valve seat material, further impede the practicality of this method.

Following the trail of innovation in valve seat cutting, a circular metal cutting head using several removable cutters has been used. Several, usually three to five, removable cutters have been used and such an arrangement has been found to eliminate the above mentioned disadvantages of other prior devices. As stated in U.S. Pat. No. 3,354,528 using irregular spaced removable cutters will eliminate the above conditions. However, several new circumstances have presented themselves in today's engines: multiple angle valve seat profiles, hardened alloy valve seats, and a focus on reproducing identical multi-angle profiles on each valve seat. The device mentioned in U.S. Pat. No. 3,354,528 performs poorly when trying to accomplish such tasks in an efficient and time saving manner That is, when trying to create a multi-angle profile on valve seats with the aforementioned device the circular metal cutting head must be swapped for the proper angle being shaped or cut on the valve seat profile. This proves to be time consuming when, for example, cutting a cylinder head with 16 valves and a minimum of 3 angles per valve seat proves to be an extremely daunting task when trying to reproduce matching valve seat profiles, reduce amount of effort used, and cost of tooling.

In an attempt to eliminate or diminish these problems, various methods have since been around as mentioned in U.S. Pat. No. 5,725,335 and U.S. Pat. No. 6,382,884 that provide a partial and very expensive solution when compared to previous methods and this present method. In as much as tooling required when operating these devices like: pilots to be inserted in valve guides are of a carbide grade which minimizes the flexion exerted by the massive ball drive. These pilots compared to regular tool steel are extremely expensive, and it is not the purpose of this application to make a monetary comparison of the investment costs but the intent and purpose is to make notice of the vast initial investment amount needed when compared to this present method.

Other methods similar to the ones mentioned above; fall under the same category of expensive operating costs (blades, pilots, and auxiliary equipment), increased setup time, and extraordinary technical knowledge to operate. Resources which are not commonly found in average machine shops or amongst enthusiasts; but nevertheless all valve seat cutting methods heretofore known suffer from a number of disadvantages:
(a) Repeatability in valve seat profiles becomes deficient when using valve seat cutter mentioned in U.S. Pat. No. 3,354,528, in as much as this process requires 3 distinct blade carriers to perform a 3 angle valve seat profile increasing the chance of varying profiles from valve seat to valve seat. Serdi® and Newen® require a program or preset configuration of valve seat profiles; which takes much skill and time to setup for each particular cylinder head available in the market.
(b) Chatter free surfaces and concentricity are achieved with great difficulty; speeds have to be adjusted due to the geometry of blades being used by both Serdi® and Newen®. The tradeoff involved with such practice is the blade turnover; a single blade cannot complete cutting multi-angle profiles on a particular cylinder head without dulling cutting at the speeds programmed by such methods above mentioned. This situation also adds to the increased cost of operation of such machines which does benefit the customer or end user at all.
(c) The time exhausted on machine setup or job setup in present use is rather extensive. If greater concentration is employed on the setup to achieve better valve seat profile finishes, the operators' productive time would decrease and the cost of the final product or service increase.
(d) A large amount of machine capability only adds to the technical knowledge needed to efficiently operate such a machine, therefore immense technical training has to be dedicated to fully apprehend and employ these machines' attributes to become productive.
   Considerable time and effort have been expended in experiment to find an angular radius for the blades capable of producing a smoother finished seat across a whole gamut of valve seat diameters, and smoother less erratic resistance to rotation. The result of this experimentation is a blade with multi-angle profiles employed differently from those previously used and which allow the blades to produce chatter free, valve concentric, and efficient valve seat profiles. As a result, it is an object of this invention to provide a valve seat cutter blade having a plurality of angle profiles used in a new method to effectively cut or shape valve seat profiles in a competitive platform.
   A further object of this invention is to provide a valve seat cutter method, as aforesaid, capable of providing a smoother, finished valve seat surface than prior methods from which it was developed, which will not tend to reproduce chatter problems occurring in the unfinished valve seat and which readily eliminates such problems.
   A further object of this invention is to provide a valve seat cutter blade, which provides a rapid setup and increases operator productive time passing these cost savings to customers or end users.
   A further object of this invention is to provide a valve seat cutter blade, which ensures a durable multi-angle profile that can effectively be transferred to a complete set of valve seats without resharpening or replacing the above mentioned blades. A further object of this invention is to provide a valve seat cutter blade, which is capable of achieving quality results with low initial investment and utilizing common equipment already in use.

A further object of this invention is to provide a valve seat cutter blade, which is achieves great results with little to no specialized training, just a simple set of instructions on how to apply the aforementioned blades. Other objects and purposes of this invention will be apparent to persons acquainted with apparatus of this general type upon reading the following description and upon inspecting the accompanying drawings.

In the drawings:

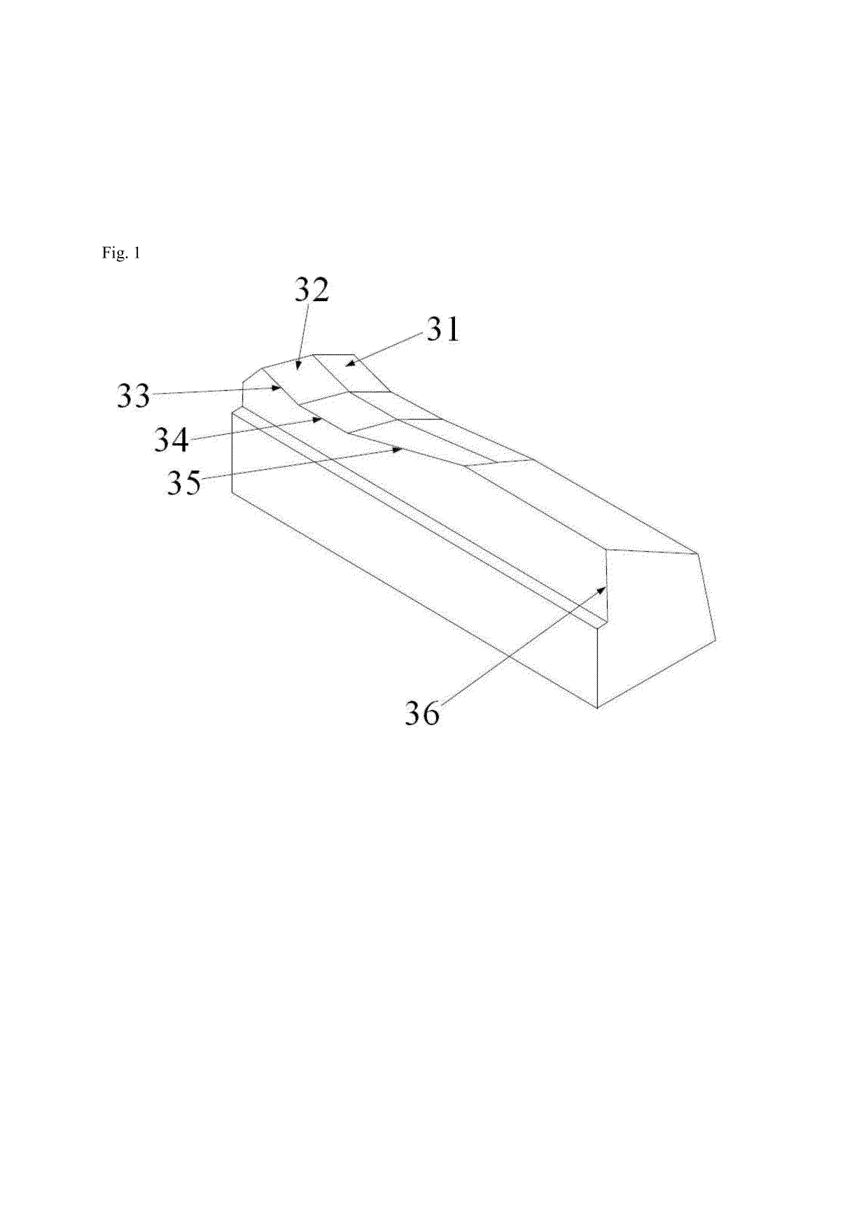

FIG. 1 is an isometric view of the valve seat cutter blade embodying the invention.

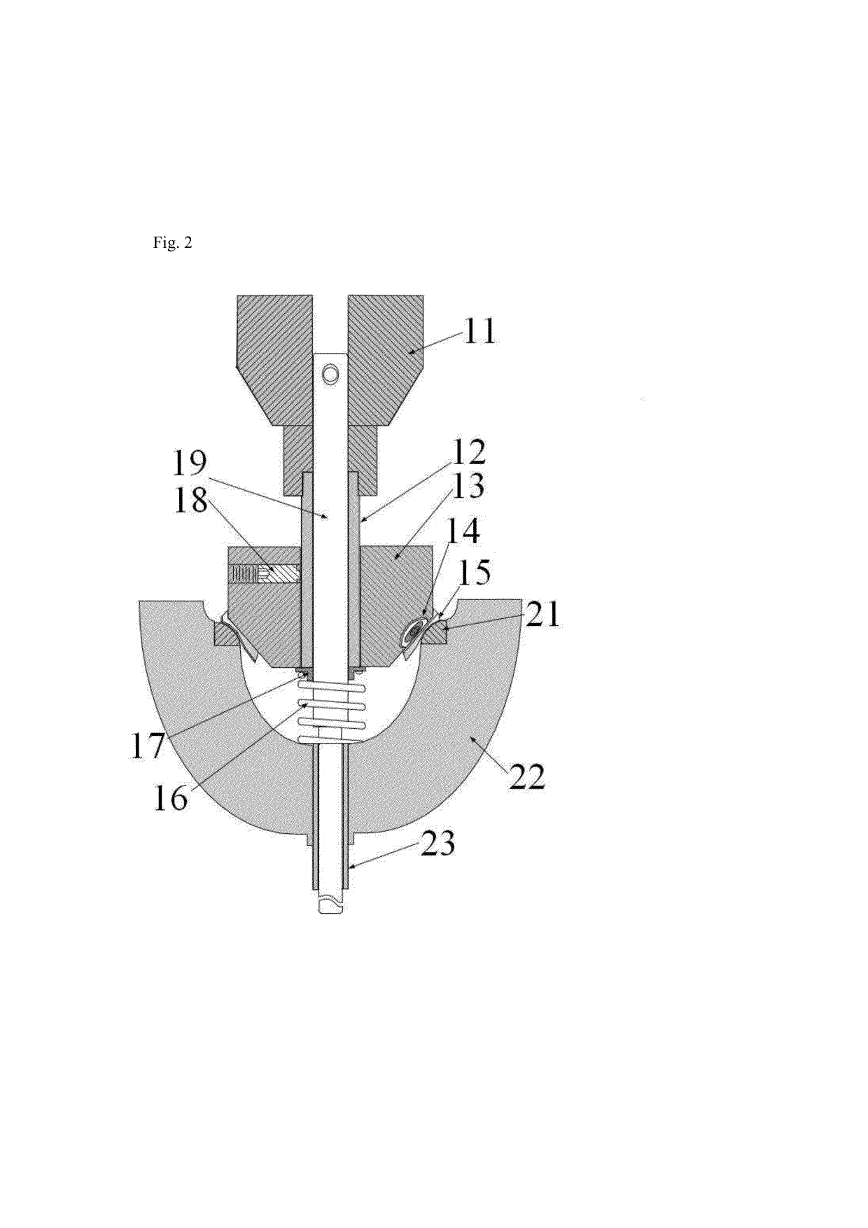

FIG. 2 is a sectional view of the fixture setup method described, employing the invention.

Certain terminology will be used in the following description for convenience in reference only and will not be limiting.

### DETAILED DESCRIPTION

### FIGS. 1 and 2

### First Embodiment

FIG. 1 is an isometric view of the three angle valve seat cutter blade constructed in accordance with the invention. The cutter 13 has grooves 14 set around the cutter 13 usually in arrangements of 3 and 5 grooves. The cutter blade or bar 15 are each of trapezoidal cross section, the base angles thereof corresponding to the angles at which the side walls of the grooves are undercut. The width of the cutter blades or bars is somewhat less than the width of their corresponding grooves to allow identical bars to be placed within the grooves. The outer or cutting face of each of the cutter blades or bars parallels the bottom of its corresponding groove. The outer face of each cutter blade has a 3 angle surface 33, 34, and 35 (FIG. 1).

FIG. 2 is view of the valve seat cutter mentioned in U.S. Pat. No. 3,354,528; 13 used to embrace multiple blades. The valve seat cutter 13 (FIG. 2) includes a generally cylindrical body. The valve seat cutter 13 (FIG. 2) is provided with a central opening 12 (FIG. 2) which is firmly but slidably disposed a generally cylindrical, hollow and elongated hub 12. In the particular embodiment shown, the ends of the hub 12 are of hexagonal cross section. The ends of 12 (FIG. 2) extend axially beyond the body 13 (FIG. 2) and are suited for engagement by a suitable wrench or the like, not shown, to cause rotation of the cutter 13 and to urge same axially against valve seat 21 (FIG. 2) to be cut and thereby renewed, such valve seat being disposed in the head or in the block of an internal combustion engine or similar device.

The outer face of each cutter blade has a 3 angle surface 33, 34, and 35 (FIG. 1). Will come in contact with valve seat 21 (FIG. 2) and as cutter 13 (FIG. 2) rotates it will cut a 3 angle profile on valve seat 21 (FIG. 2): top, seat, and throat angle. Angles are pitched so that their cutting edge faces leftwardly and radially outwardly as seen from the axis of cutter 13 (FIG. 2) and hence, are arranged for cutting when cutter 13 (FIG. 2) is rotated in a counterclockwise direction as seen from valve seat 21 (FIG. 2). To provide a smooth finish cutter blades 15(FIG. 1) are machined to have relief and rake angles 31 (FIG. 1) and 33 (FIG. 1) respectively. These angles 31 (FIG. 1) and 33 (FIG. 1) work in conjunction with cutting angle 32 (FIG. 1) that allow a chatter free finish for any type of cylinder head made out of any material. Such cutting rotation would therefore appear as a clockwise rotation when viewed from the end of the body away from valve seat and toward operator that is, the upper end of valve cutter 13 as seen in FIG. 2. The driving force is usually of the nature of a ½ inch drive socket propelled by a valve seat cutting machine or machine of a drill press character.

Cutter blade or insert 15 (FIG. 2) are normally wedged against the trailing side wall of their respective grooves by preferably identical holding means generally indicated at 18. Such holding means each comprises a flat head machine screw threaded in cutter 13 (FIG. 1).

### OPERATION

Use a valve edge indicator or blade setting fixture to find the valve's edge. Once valve's edge is found, insert valve seat cutter 13 (FIG. 2) onto pilot 19 (FIG. 2) and securely fasten a valve edge indicator to pilot (FIG. 2). The pointer will be facing the up towards blades. Place blade in slot 14 in this case (FIG. 2) other type of valve seat cutter mentioned in U.S. Pat. No. 3,354,528 which requires 3 or 5 blades. Then each blade should be adjusted sliding up or down so the pointer lies or indicates a junction formed between the first two angles. Do this to every blade on the valve seat cutter mentioned in U.S. Pat. No. 3,354,528. Securely tighten all the blades and remove the valve edge indicator from the pilot as well as the cutter mentioned in U.S. Pat. No. 3,354,528. Insert the pilot into the valve guide that corresponds to the valve seat that will be machined. Using a valve seat and guide machine, securely fasten and level the cylinder head. Once the cylinder head is level, center the machine's spindle with the valve guide pilot 19 (FIG. 2). After both are centered, slide a bounce spring 16 (FIG. 2) over pilot 19 (FIG. 2). Now slide valve seat cutter 13 (FIG. 2) onto pilot 19 (FIG. 2) thus permitting on bounce spring 16 (FIG. 2). When spindle 11 (FIG. 2) turns valve seat cutter 13 (FIG. 2), a three angle profile will be cut into valve seat 21 (FIG. 2) to form a surface concentric with valve surface; allowing improved sealing capabilities to occur. The use of these blades produces 5 key benefits:
(1) the three angle profile with rake angle 33 and relief angle 31 (FIG. 1) will produce a chatter free cut.
(2) Repeatability is improved due to an initial one time setup of blades.
(3) Cost of machining three angle profiles on valve seats is reduced.
(4) Machine setup is quicker; therefore the whole machining process is much quicker compared to existing valve seat cutting methods.
(5) No advanced or specialized technical training is required to execute this method.
(6) The operator can use these blades on any type of cylinder head.
(7) Longer blade life, up to 3 even 5 times longer life compared to single blade valve seat cutters.

Although the embodiment above contains numerous geometries, these should not limit the scope of the embodiments but merely ascertain the presently preferred embodiments. For instance, the blade may cut more or less than three angle profiles, edges are not restricted to being flat or straight, and angles such as relief, rake are used for reference but the blade is not limited to the ones mentioned in this description.

Thus the scope of the embodiments should be determined by the appended claims and their legal equivalents, rather than by the examples given. The embodiments of the invention in which an exclusive property or privilege is claimed are defined as follows:

What is claimed is:

1. A valve seat facing blade comprising the combination:
a. multi-angle profiles or faces on the surface of said blade in such a manner that will reface the surface of a valve seat.
b. rake and relief angle arrangement that performs concentric and chatter free valve seat surfaces.
c. array of angled surfaces on said blades positioned in a manner that permit sharpening when dull.
d. said blades can be used for manual valve seat resurfacing.

2. A method comprising the combination:
a. said cutting blades on a valve seat cutter holder mentioned in U.S. Pat. No. 3,354,528 or similar apparatus that allows positioning of mentioned blades for increased valve seat resurface throughput.
b. seat and guide machine that will rotate said valve seat cutter or similar apparatus in a valve seat diameter using the mentioned multi-angle valve seat cutter blades to perform a valve seat resurface.
c. said method minimizes tooling required to perform valve seat resurfacing.
